(19) United States
(12) Patent Application Publication
(10) Pub. No.: US 2025/0370282 A1
(43) Pub. Date: Dec. 4, 2025

(54) INTEGRATING HMI SENSORS WITH SMART WINDOWS

(71) Applicant: Qorvo US, Inc., Greensboro, NC (US)

(72) Inventor: Yuyang Ying, Fremont, CA (US)

(21) Appl. No.: 19/202,224

(22) Filed: May 8, 2025

Related U.S. Application Data
(60) Provisional application No. 63/652,486, filed on May 28, 2024.

(51) Int. Cl. G02F 1/01; E06B 9/24; G01K 13/00; G01L 5/00; G01S 13/04

(52) U.S. Cl. CPC G02F 1/0121; E06B 9/24; G01K 13/00; G01L 5/0052; G01S 13/04; E06B 2009/2417

(57) ABSTRACT

Embodiments of a smart window having a controllable tint state are disclosed. In one embodiment, a smart window includes one or more glass panels, and one or more Micro-Electro-Mechanical System (MEMS)-based force sensors either integrated directly with at least one of the one or more glass panels or integrated into a mullion or transom adjacent to the one or more glass panels. In one embodiment, at least one of the one or more MEMS-based force sensors is configured to function as a button. Embodiments of method of controlling the tint state of a smart window based on an output of a MEMS-based force sensor integrated with the smart window are also disclosed.

### RELATED APPLICATIONS

This application claims the benefit of U.S. Provisional Patent Application No. 63/652,486, filed May 28, 2024, the disclosure of which is hereby incorporated herein by reference in its entirety.

### FIELD OF THE DISCLOSURE

The present disclosure relates to a smart window having a controllable tint level.

### BACKGROUND

Smart Window technology is an emerging technology that is gradually transforming occupancy experience in the real estate industry as well as automotive industry by changing the color (i.e., the tint or the light transmission properties) of the window according to different inputs or controls. In comparison, traditional windows, in a sense, “dumb” windows, cannot change their color and, as such, occupants of a building residence need to use blinds or shades to block the sun or heat passing through the window. In the case of the automotive industry, cars must add special tint films to the windows to block the sun and reduce the heat. Alternatively, in other higher end cars, there may be automatic or manual “sunshades” to make passengers more comfortable in the car.

### SUMMARY

Embodiments of a smart window having a controllable tint state are disclosed. In one embodiment, a smart window includes one or more glass panels, and one or more Micro-Electro-Mechanical System (MEMS)-based force sensors either integrated directly with at least one of the one or more glass panels or integrated into a mullion or transom adjacent to the one or more glass panels. In one embodiment, at least one of the one or more MEMS-based force sensors is configured to function as a button. In this manner, a smart window with a designer-programmable and user-controllable tint state is provided.

Embodiments of a method of controlling the tint state of a smart window based on an output of a MEMS-based force sensor integrated with the smart window are also disclosed. In one embodiment, a method of controlling a tint state of a smart window includes detecting a user input based on an output of a MEMS-based force sensor that is either integrated directly with a glass panel of the smart window or integrated into a mullion or transom adjacent to the glass panel of the smart window, the user input including either a press or a sequence of presses on a surface of either the glass panel of the smart window or the mullion or transom adjacent to the glass panel of the smart window. The method further includes controlling a feature of the smart window based on the detected user input. In one embodiment, the feature of the smart window controlled based on the detected user input is a tint state of the smart window.

In one embodiment, at least one of the one or more MEMS-based force sensors is configured to function as a button. In one embodiment, the smart window further includes one or more Ultra-Wideband (UWB) sensors configured to detect presence of one or more occupants. In another embodiment, the smart window includes one or more UWB sensors configured to detect presence of one or more occupants within a certain distance from the smart window or within a room or space in which the smart window is located. In one embodiment, the smart window further includes a temperature sensor integrated directly with at least one of the one or more glass panels or integrated into a mullion or transom adjacent to the one or more glass panels.

In one embodiment, the one or more glass panels comprise a glass panel having a first side that faces a room or space in which an occupant may be present and a second side that is opposite to the first side, and the one or more MEMS-based force sensors includes a MEMS-based force sensor that is attached to the second side of the glass panel and configured to sense a force applied to the first side of the glass panel and thereby function as a button.

In one embodiment, the one or more MEMS-based force sensors includes a MEMS-based force sensor that is attached to an interior side of a surface of a mullion or transom adjacent to the one or more glass panels and configured to sense a force applied to the surface of the mullion or transom and thereby function as a button.

In one embodiment, the smart window further includes a controller configured to control a feature (e.g., a tint state) of the smart window based on one or more inputs, the one or more inputs including an output of the MEMS-based force sensor configured to function as a button.

In another aspect, any of the foregoing aspects individually or together, and/or various separate aspects and features as described herein, may be combined for additional advantage. Any of the various features and elements as disclosed herein may be combined with one or more other disclosed features and elements unless indicated to the contrary herein.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIG. 1 illustrates one example of a structure including multiple smart windows having controllable tint states, wherein the smart windows are integrated with Micro-Electro-Mechanical System (MEMS)-based force sensors at least one of which functions as a button, in accordance with embodiments of the present disclosure.

FIG. 2 illustrates one example embodiment in which a MEMS-based force sensor is directly integrated to a back-side of a top surface of either a glass panel of the smart window or the mullion (or transom) adjacent to the glass of the smart window.

FIG. 3 illustrates a system in accordance with one example embodiment of the present disclosure;

FIG. 4A illustrates an example control mechanism for controlling the tint of a smart window by either tapping on the window different times with same/similar force level or tapping/pressing on the window only once but with different force levels for different tint levels, in accordance with an embodiment of the present disclosure.

FIG. 4B illustrates another example control mechanism for controlling the tint of a smart window via an array of MEMS-based force sensors functioning as a sliding bar where a touching a sliding across the sliding bar results in changing the tint of the glass of the smart window;

FIG. 5 is a flow chart illustrating a procedure for controlling the tint of the smart window, in accordance with another example embodiment of the present disclosure.

FIG. 6 is a flow chart illustrating a procedure for controlling the tint of the smart window, in accordance with another example embodiment of the present disclosure.

FIG. 7 is a flow chart that illustrates one example process that may be performed by the smart window controller to detect button press and/or a breakage/hazardous impact, in accordance with one example embodiment of the present disclosure.

FIG. 8 illustrates one example of the output of the MEMS-based force sensor and example thresholds for detecting a press or breakage/hazardous impact.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element such as a layer, region, or substrate is referred to as being “on” or extending “onto” another element, it can be directly on or extend directly onto the other element or intervening elements may also be present. In contrast, when an element is referred to as being “directly on” or extending “directly onto” another element, there are no intervening elements present. Likewise, it will be understood that when an element such as a layer, region, or substrate is referred to as being “over” or extending “over” another element, it can be directly over or extend directly over the other element or intervening elements may also be present. In contrast, when an element is referred to as being “directly over” or extending “directly over” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Embodiments are described herein with reference to schematic illustrations of embodiments of the disclosure. As such, the actual dimensions of the layers and elements can be different, and variations from the shapes of the illustrations as a result, for example, of manufacturing techniques and/or tolerances, are expected. For example, a region illustrated or described as square or rectangular can have rounded or curved features, and regions shown as straight lines may have some irregularity. Thus, the regions illustrated in the figures are schematic and their shapes are not intended to illustrate the precise shape of a region of a device and are not intended to limit the scope of the disclosure. Additionally, sizes of structures or regions may be exaggerated relative to other structures or regions for illustrative purposes and, thus, are provided to illustrate the general structures of the present subject matter and may or may not be drawn to scale. Common elements between figures may be shown herein with common element numbers and may not be subsequently re-described.

Like a lot of other new technologies, Smart Window technology comes with numerous defects that need to be overcome in order to be accepted by the general market. First of all, a Smart Window is supposed to be “smart” but most of the products in the market today lack an intuitive way of control. One specific difficulty comes from a fundamental hardware limitation that it is difficult to integrate a mechanical button or capacitive-touch button into a window. As such, existing Smart Window solutions allow users to control the tint of smart windows through a smart phone application or web portal or rely on automatic control of the tint of the windows by an associated controller based on various sensor inputs. Note that some prior smart window solutions used mechanical buttons, but such solutions are not customizable and it is difficult to map mechanical buttons to the window, unless there is a one-on-one mapping between the button and the window, which will lead to a more costly solution.

In regard to control of smart windows via an application or web portal, because there are oftentimes many windows in a building and oftentimes several if not many windows in a single room of a building, the user cannot easily find a particular window that the user desires to control from among the many windows available in the application or web portal. Instead, the user must rely on group control of the smart windows (e.g., controlling the tint of all smart windows of a building) or forego the use of the control feature of the application or web portal and instead rely on automatic control of the tint of the smart windows by an associated controller.

In regard to automatic control of the smart window, the existing automatic control solutions are not “smart” enough. The most advanced Smart Window can change the color/tint based mostly on inputs about the weather and/or overrides of the users (via the application or web portal), but the existing solutions do not take into account whether occupants are present in the room in which the window is located.

Secondly, the cost of current Smart Windows is high while the benefits are typically limited to changing the tints of the windows. Some companies, such as View, Inc., have attempted to increase the benefits of Smart Windows by integrating Smart Window technology with Televisions (TVs) or by adding features such as “Smart Protect” which basically detects if there is a window breakage by theft or some other hazards; however, existing solutions for providing these additional benefits use complex hardware or software solutions. There have also been many attempts to integrate other sensors into the mullions or the control panel which connect the windows, but these effects are still costly and will require substantial room/cost to develop.

Embodiments of a smart window integrated with one or more Micro Electro-Mechanical Systems (MEMS)-based force sensors as well as embodiments of methods of controlling a smart window(s) based on the output(s) of such MEMS-based force sensor(s) are disclosed herein. In the preferred embodiments, the MEMS based force sensor(s) is (are) material agnostic and, as such, can be either (a) integrated directly into the smart window (e.g., attached to an interior surface of a multi-panel window) or (b) integrated in a mullion or transom adjacent to the smart window. At least one MEMS-based force sensor functions as a button to control a feature of (e.g., the tint of) the smart window (or a group of one or more smart windows, e.g., a group of adjacent smart windows). The use of the MEMS-based force sensor(s) provide very customizable solutions and lower cost compared to mechanical buttons or the use of capacitive-touch.

Additionally, using MEMS-based force sensor(s) enables the addition of more features in a simple and low-cost manner. For example, using one or more MEMS-based force sensors integrated with the smart window, breakage of the window or a hazardous impact to the window can be detected when the force detected by the MEMS-based force sensor(s) exceeds a certain threshold, where this threshold may be programmable and/or customizable.

In addition, the MEMS-based force sensor may be integrated with other types of sensors (e.g., a temperature sensor), which enables the detection of the temperature of the window. The temperature of the window may then be used by an associated controller (e.g., as a proxy for the temperature of the room) as an input for a smart control mechanism for controlling the tint of the smart widow based on various inputs such as temperature. Temperature may be used to enable passive/active cooling or heating of the room by being used as an input of the controller of the Smart Window or by being used as an input to an associated Building Management System (BMS), to make the window, the home, or the building smarter. Integration of temperature sensor(s) with Smart Windows or BMS can be used to control or downsize the HVAC for the home/building, thus saving the energy.

Last but not least, Smart Windows can also be integrated with Ultra-Wideband (UWB) sensors, which can be used to detect human presence in real time. As such, in some embodiments, the output(s) of the integrated UWB sensor(s) are used as an input(s) to the automatic control system for the Smart Window. One example control procedure is as follows:
1. If, based on the output(s) of the UWB sensor(s), it is determined that there are occupants in the room near the smart window, the controller tints (or increases the tint) of the smart window such that the occupants are protected from direct glare, if it is a sunny day. But if it is a cloudy day, the controller may control the smart window such that the window is clear (i.e., no tint) even if occupant(s) are present.
2. If based on the output(s) of the UWB sensor(s), it is determined that no occupants are present in the room near the smart window, the controller controls the smart window such that: (a) the smart window is clear (i.e., no tint) if the temperature is less than a threshold (e.g., on a cold day or during in the winter) to let more sunlight into the room thus passively heating the room to help reduce the load of the HVAC or (b) the smart window is tinted if the temperature is above a threshold (e.g., on a hot day or during the summer) to reduce the sunlight coming into the room thereby passively cooling the room for energy savings.

Embodiments of the present disclosure include the following aspects:
a smart window (aka. Dynamic Windows) having a controllable amount of tint (i.e., controllable tint level),
one or more MEMS-based force sensors integrated with the smart window (e.g., directly in the smart widow or in the mullion or transform adjacent to the window),
   At least one of the MEMS-based force sensors functions as a button in the sense that an associated controller detects a user pressing on the glass of the smart window, where the detected touch is used as an input to a controller of the smart window to control the tint of the smart window (and/or to a controller of multiple smart windows such as, for example, a Building Management System (BMS)).
   The same MEMS-based force sensor(s) that function as a button, and optionally one or more additional MEMS-based force sensors, are, in some embodiments, further used to detect a breakage or hazardous impact on the smart window.
optionally, one or more sensors integrated with the smart window such as, e.g., a temperature sensor and/or a UWB sensor.

Embodiments of a control procedure for controlling the smart window based on output(s) of the MEMS-based force sensor(s) and optionally the one or more other sensors (e.g., temperature sensor and/or UWB sensor).

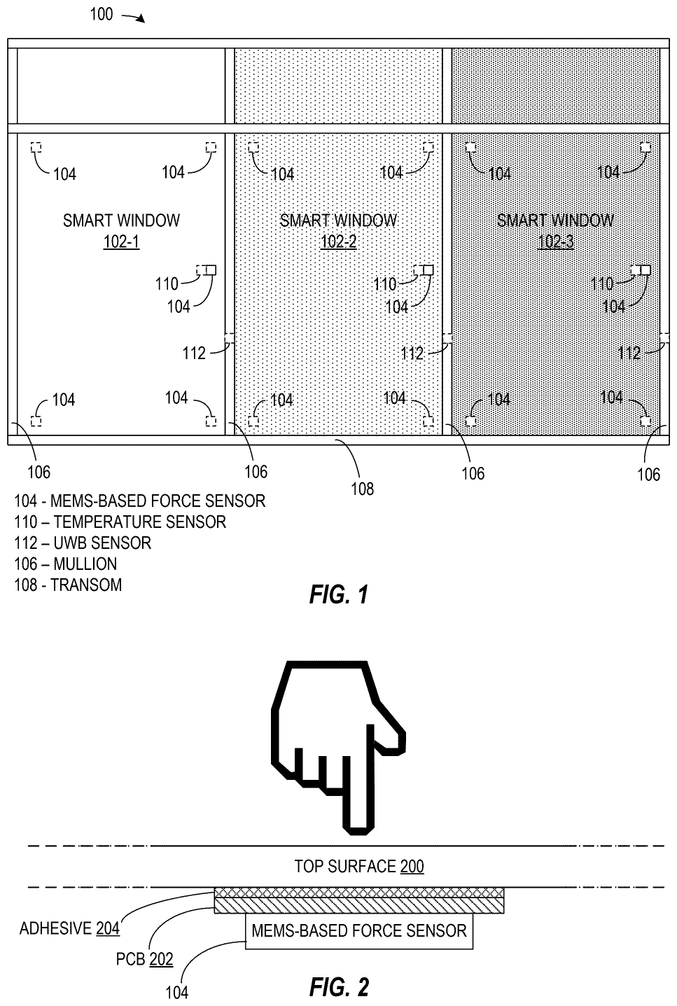

In this regard, FIG. 1 illustrates one example of a structure 100 including multiple smart windows 102-1, 102-2, and 102-3, which are generally referred to herein individually as a smart window 102 and collectively as smart windows 102. In this example, there are three smart windows 102; however, this is only any example. There may be any number of one or more smart windows 102. Note that optional features are represented by dashed lines.

One or more MEMS-based force sensors 104 are integrated with each smart window 102. Each MEMS-based force sensor 104 is integrated either directly into the associated smart window 102 (i.e., directly integrated onto a glass panel of the smart window 102) or integrated into the mullion 106 or transom 108 adjacent to the smart window 102. Note that, due to the fact that bending of the glass panel of the smart window 102 is very limited, the force cannot be transferred via the glass to the MEMS-based force sensor 104 if the glass is pressed too far away from the MEMS-based force sensor 104. Therefore, in some embodiments, two or more MEMS-based force sensors 104 are integrated with the smart window 102 (e.g., two MEMS-based force sensors 104 (one on each side of the glass or one on each mullion adjacent to each side of the glass) or four MEMS-based force sensors 104 (one on each corner of the glass)) may be preferred in order to have better signal. For example, if detection of a glass breakage (or an attempted breakage) is desired, two or more MEMS-based force sensors 104 are likely needed to pick up the force signal from any location on glass.

Optionally, in some embodiments, a temperature sensor 110 and/or a UWB sensor 112 may also be integrated with the smart window 102 (e.g., directly into the glass of the smart window 102 and/or in the mullion 106 or transom 108 adjacent to the smart window 102). Note that while the temperature sensor 110 is illustrated in FIG. 1 as being separate from the MEMS-based force sensor(s) 104, the temperature sensor 110 may either be a separate sensor or integrated with one of the MEMS-based force sensors 104. In other words, the temperature sensor 110 and one of the MEMS-based force sensors 104 may be integrated into a single Human-Machine Interface (HMI) sensor that senses both temperature and force. As such, while referred to separately herein, the separate references to the temperature sensor 110 and the MEMS-based force sensor 104 do not preclude a combined sensor that senses both temperature and force unless explicitly stated otherwise.

FIG. 2 illustrates one example embodiment in which a MEMS-based force sensor 104 is directly integrated to a back-side of a top surface 200 of either a glass panel of the smart window 102 or the mullion 106 (or transom 108) adjacent to the glass of the smart window 102. For instance, if the smart window 102 is an insulated window including two or more glass panels separated by an air gap, then the top surface 200 is the glass panel that can be directly touched by the user, and the MEMS-based force sensor 104 is attached to a back-side of this glass panel. In this example, the MEMS-based force sensor 104 is electrically and mechanically connected to (e.g., soldered to) a Printed Circuit Board (PCB) 202, and the PCB 202 is attached to the back-side of the top surface 200 via an adhesive 204. In one example embodiment, the MEMS-based force sensor 104 is one of the family DF-880x of MEMS-based force sensors manufactured and sold by Qorvo®. In one example, the PCB 202 is a 0.4 millimeter (mm) thick FR4 PCB. In preferred embodiments, the MEMS-based force sensor 104 is able to detect a force as small as a few grams.

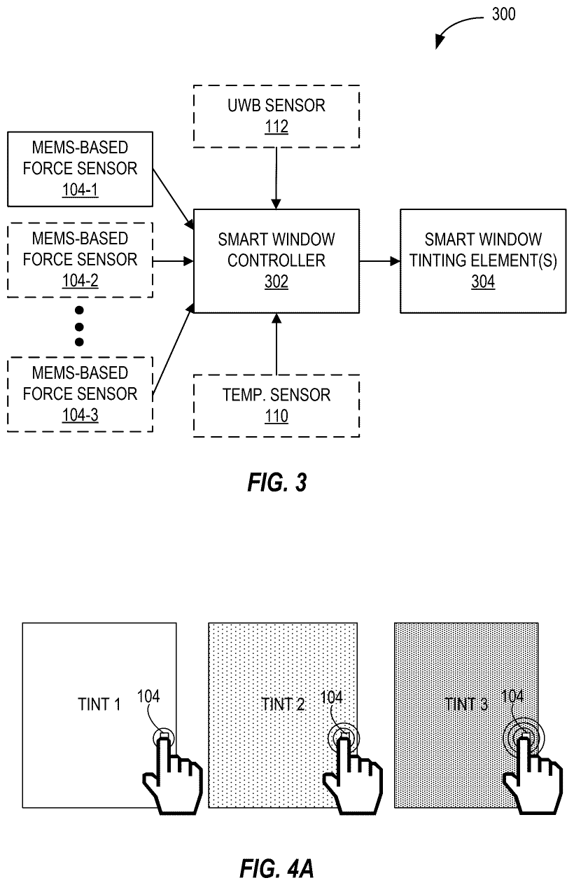

FIG. 3 illustrates a system 300 in accordance with one example embodiment of the present disclosure. The system 300 includes a smart window controller 302 that controls one or more smart window tinting elements 304 to control the tint of the smart window 102. The smart window controller 302 may be integrated with the smart window 102 (e.g., integrated into the mullion 106 or transom 108 adjacent to the smart window 102) and may include one or more processors (e.g., one or more Central Processing Units (CPUs), one or more Application Specific Integrated Controllers (ASICs), one or more Digital Signal Processors (DSPs), one or more Field Programmable Gate Arrays (FPGAs), or the like, or any combination thereof)). In some embodiments, a control scheme (or at least a portion thereof) is implemented in software that is stored in memory and executed by the one or more processors. In an alternative embodiment, the smart window controller 302 controls multiple smart windows or is part of a larger control system such as, e.g., a BMS and is potentially remote from the smart window 102 (e.g., implemented as a separate control system either on-premises or in the cloud).

The one or more smart window tinting elements 304 are any type of element that can be controlled by the smart window controller 302 to control the tinting, or color, of the glass of the smart window 102. The elements here mostly refer to the active glass technologies. For example, the smart window tinting elements 304 may be electrochromic devices and/or liquid crystal and suspended particles devices (SPD) integrated into the smart window 102 that operate to change the tinting of the glass of the smart window 102, as is well-known to those of ordinary skill in the art.

In general, the smart window controller 302 controls the smart window tinting element(s) 304 of the smart window 102 (and thus controls the tinting of the smart window 102) based on output(s) of the MEMS-based force sensor(s) 104 and optionally outputs of one or more additional sensors, which in this example may include the temperature sensor 110 and/or the UWB sensor 112. Note that in the preferred embodiments, at least one MEMS-based force sensor 104 is used to provide the functionality of a button that can be pressed by a user to control the tint of the smart window 102.

The control procedure implemented by the smart window controller 302 may depend on hardware and/or software requirements and the intended application. For example, the area of the top surface 200 of the glass of the smart window 102 or of the mullion 106 or transom 108 opposite to the MEMS-based force sensor 104 may function as a button, wherein some visual button on that area of the top surface 200 indicates to the user where to press. The user pressing on that area of the top surface 200 is detected by the smart window controller 302 (based on the output of the MEMS-based force sensor 104) as a button press, which in turn triggers an event (e.g., switching between two or more tint levels such as, e.g., clear, light tint, medium tint, and dark tint). In this manner, the user may press on the top surface 200 to cycle through two or more tint levels.

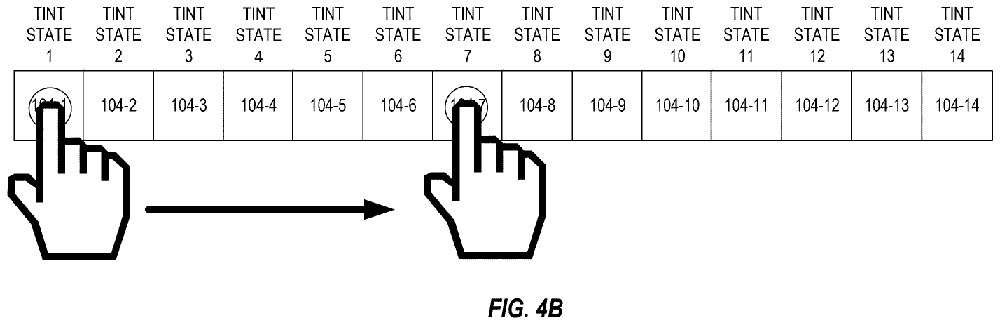

As another example, the MEMS-based force sensor 104 may be used to detect different sequences of button presses where different sequences of button presses are mapped to different tint levels (e.g., press once to go to tint level 1 (clear), press twice to go to tint level 2 (e.g., lowest tint), press three times to go to tint level 3 (e.g., 2^{nd} lowest tint level), and so on). This example is illustrated in FIG. 4A. Note that the different sequences of button presses may also consider amount of force and/or duration (e.g., short press mapped to tint level 1, two short presses mapped to tint level 2, long press mapped to tint level 3, and two long presses mapped to tint level 4).

As yet another example, different amounts of force may be mapped to different tint levels (e.g., range of force level F1 to F2 mapped to tint level T1, range of F2 to F3 mapped to tint level T2, range of F3 to F4 mapped to tint level T3, etc., where F1<F2<F3<F4, etc.).

With two or more MEMS-based force sensors 104 integrated at one spot for example into the transom under the glass of the smart window 102, a slider can also be developed to control different tint levels, with the finger pressed on the leftmost position of the slider corresponding to lowest tint level and the right most position of the slider corresponding to highest tint level. An example is illustrated in FIG. 4B where a user touch over MEMS-based force sensor 104-1 results in the tint state of the smart window 102 being set to a first tint state (Tint State 1, which may be clear), sliding across the touch bar to 104-7 results in the tint state of the smart window 102 changing to Tint State 7 (potentially sequentially switching from Tint State 1 to Tint State 2 to Tint State 3 and so on as the user slides his or her finger across the touch bar from above the MEMS-based force sensor 104-1 to above the MEMS-based force sensor 104-7.

In addition to the button press or sequence of button presses detected via the MEMS-based force sensor 104, the control procedure implemented by the smart window controller 302 may additionally consider outputs of one or more additional sensors such as, e.g., the UWB sensor 112 and/or the temperature sensor 110, and/or other types of sensors (e.g., light sensor that detects amount of sunlight hitting the smart window 102).

For example, the UWB sensor 112 is, in some embodiments, used to develop real-time location system that detects the presence of an occupant(s) in the room or the presence of an occupant(s) within a certain distance from the smart window 102. Note that, in some embodiments, the UWB sensor 112 is integrated with its own controller unit that processes the output of the UWB sensor 112 to detect the presence of an occupant(s), where an indication of the presence (or lack of presence) of an occupant(s) is then provided to the smart window controller 302. Alternatively, this controller of the UWB sensor 112 may be implemented as part of the smart window controller 302.

Depending on the particular implementation, the UWB sensor 112 may be much larger than the MEMS-based force sensor 104 and, as such, integrated into the mullion 106 or transom 108, rather than directly into the glass of the smart window 102. Note that, in one example embodiment, the UWB sensor 112 is able to cover up to 50 meters (m) or up to 200 m, and as such, one UWB sensor 112 is likely sufficient to detect the presence of occupant(s) for the whole room or space, in most scenarios.

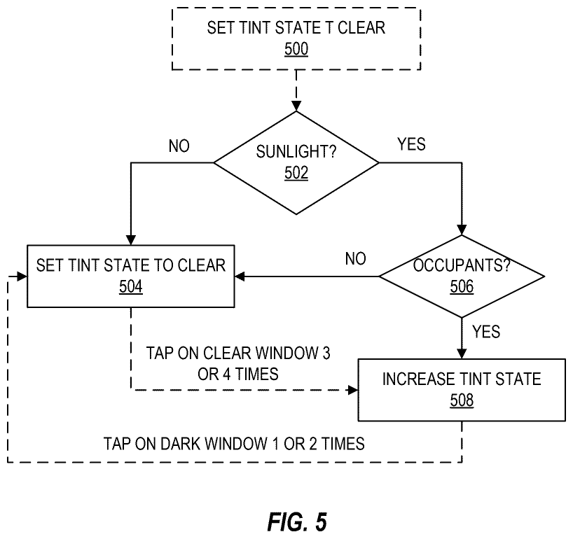

FIG. 5 is a flow chart illustrating a procedure performed by the smart window controller 302 for controlling the tint of the smart window 102, in accordance with one example embodiment of the present disclosure. Optional steps are represented by dashed lines. The steps of the procedure of FIG. 5 are as follows:
Step 500 (Optional): The smart window controller 302 initializes the tint of the smart window 102 to a clear tint state (i.e., no tinting).
Step 502: In this example, the smart window controller 302 determines whether there is sunlight, or at least a threshold amount or level of sunlight, hitting the smart window 102. This may be done based on input from a light sensor (not shown), which may be integrated with the smart window 102, or by receiving information about the current weather conditions from a remote source (e.g., via the Internet). If there is no sunlight or if the amount of sunlight is less than the threshold amount or level (step 502, NO), the process proceeds to step 504. Otherwise, the process proceeds to step 506.
Step 504: In this example, if there is no sunlight or if the amount of sunlight is less than the threshold amount or level (step 502, NO), the smart window controller 302 sets the tint of the smart window 102 to the clear state (no tint). Note that if the smart window 102 is already in the clear state, then no action may be performed. While the smart window 102 is set to the clear tint state, upon detecting a certain tap sequence (e.g., in this example, 3 or 4 taps or presses by a user) via the MEMS-based force sensor 104, the process proceeds to step 508 where the smart window controller 302 increases the tint of the smart window 102 (e.g., to a preset tint state, to a tint state mapped to the detected sequence of taps/presses, or the like).
Step 506: If there is sunlight or if the amount of sunlight is greater than the threshold amount or level (step 502, YES), the smart window controller 302 determines, based on the output of the UWB sensor 112, whether there are any occupants in the associated room or space or near the smart window 102 (e.g., within a certain distance from the smart window 102 or within a detection range of the UWB sensor 112). If not, the process proceeds to step 504. Otherwise, if one or more occupants are detected, the process proceeds to step 508 to thereby increase the tint of the smart window 102. In this manner, passive cooling of the room/space is provided while the occupants are present.
Step 508: The smart window controller 302 increases the tint of the smart window 102. For example, the smart window 102 may have two tint states (clear and tinted), and the tint state of the smart window 102 is set to the tinted state in step 508. In another example, the smart window 102 has multiple tint states that are mapped to different detected levels (or ranges of detected levels) of sunlight, and the tint of the smart window 102 is set to the tint state that is mapped to the detected level of sunlight. While in this tint state, upon detecting a certain tap sequence (e.g., in this example, 1 or 2 taps or presses by a user) via the MEMS-based force sensor 104, the process proceeds to step 504 where the smart window controller 302 decreases the tint of the smart window 102 (e.g., to the clear tint state in this example).

Note that a more complex control procedure may use the location of the occupant(s) within the room or space as detected via the UWB sensor 112 and map the location of the occupant(s) to a 3D model of the room or space to control the smart window 102 more precisely. For example, instead of just darkening the room with the presence of the occupant(s) (via increasing the tint of the smart window 102), the smart window controller 302 may make the glass of the smart window 102 gradually darker when the sunlight in the room approaches the occupant(s). If the sunlight never approaches the occupant(s), the glass can stay clear, e.g., to allow the occupant(s) to enjoy the beautiful outside view.

Note that the process of FIG. 5 may combine multiple inputs (e.g., input from weather feed that provides current weather conditions and UWB sensor 112 output) to control the smart window 102. In the example of FIG. 5, a sunlight sensor and the UWB sensor 112 are used to provide automatic control of the tinting of the smart window 102, and optionally the MEMS-based force sensor(s) 104 enable manual override of the tint of the smart window 102 by a user.

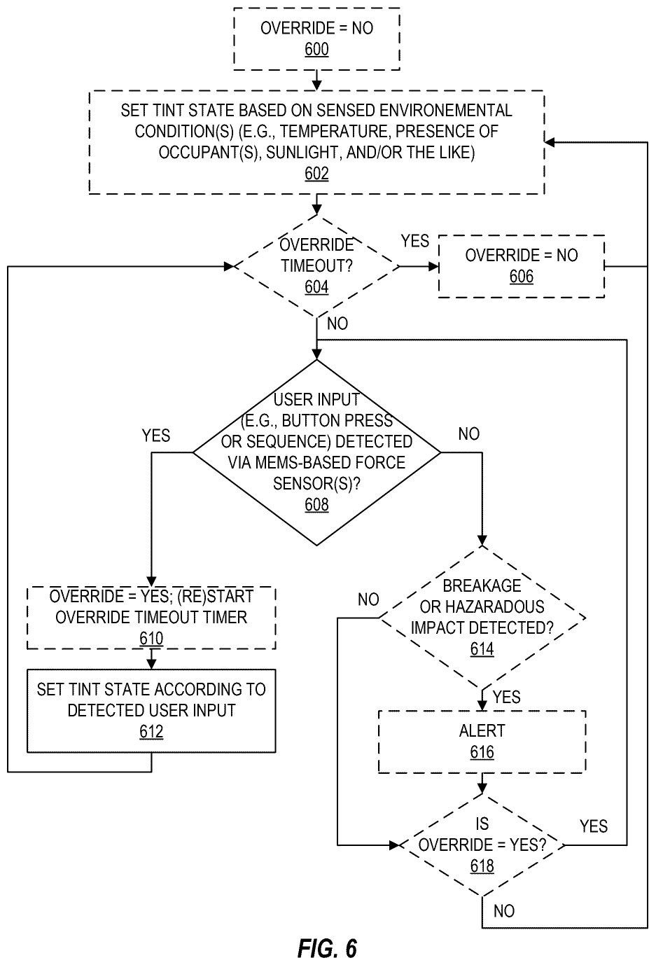

FIG. 6 is a flow chart that illustrates a control process performed by the smart window controller 302 for controlling the tint of the smart window 102, in accordance with another example embodiment of the present disclosure. Note that optional steps are represented by dashed lines. The steps of the procedure are as follows:
Step 600 (Optional): The smart window controller 302 sets an override state to ‘NO’. The override state is a state which is entered responsive to detection of a user input (via the MEMS-based force sensor(s) 104) that causes the user input override the automatic control mechanism to set the tint state of the smart window 102.
Step 602 (Optional): The smart window controller 302 sets the tint state of the smart window 102 based on one or more sensed or otherwise obtained environmental conditions such as, for example, any one or more of the following: temperature (e.g., based on output of the temperature sensor 110), presence of one or more occupants (e.g., based on output of the UW B sensor 112), sunlight (or amount of sunlight), and/or the like, or any combination thereof. In this step, any suitable automatic decision process may be used.
Steps 604 and 606 (Optional): The smart window controller 302 determines whether the smart window is in the override state and, if so, whether an override timeout has occurred. The override timeout is a duration of time after detecting a user input in which the smart window 102 will remain in the override state. When the smart window 102 is in the override state and the override timeout has occurred, in this example, the smart window 102 returns to the automatic control state by setting an override indicator to ‘NO’ (step 606) and returning to step 602.
Step 608: The smart window controller 302 determines whether user input (e.g., a button press or sequence) is detected based on the output of the MEMS-based force sensor(s) 104. If so, the process proceeds to step 610. Otherwise, the process proceeds to step 614.
Step 610 (Optional): The smart window controller 302 sets the override indicator to ‘YES’. In other words, the smart window controller 302 stores an indicator that a user input has been detected, which causes the smart window 102 to enter the override state.
Step 612: The smart window controller 302 sets the tint state of the smart window 102 according to the detected user input. For example, each detected button press may cause the smart window controller 302 to cycle through the set of possible tint states, in which case, in step 612, the smart window controller 302 sets the tint state of the smart window 102 to the next tint state. As another example, different button press sequences (e.g., 1 press, 2 presses, 3 presses, etc.) or different detected force levels may be mapped to different tint states, in which case, in step 612, the smart window controller 302 sets the tint state of the smart window 102 to the tint state that is mapped to the detected button press sequence or to the detected amount of force for the press. Other variations are possible, as will be appreciated by one of ordinary skill in the art upon reading this disclosure. The process then returns to step 604.
Step 614 (Optional): The smart window controller 302 determines whether a breakage or hazardous impact is detected based on the outputs of the MEMS-based force sensors 104. This may be, for example, detecting whether the force detected by any one or more of the MEMS-based force sensors 104 exceeds a certain force threshold that is indicative of a breakage or hazardous impact. If a breakage or hazardous impact is not detected, the process proceeds to step 618. Otherwise, the process proceeds to step 616.
Step 616 (Optional): The smart window controller 302 raises an alert (e.g., sends an alert indication to an associated BMS, sounds an alarm, and/or the like).
Step 618 (Optional): The smart window controller 302 determines whether the smart window 102 is in the override state. If so, the process returns to step 608. If not, the process returns to step 602.

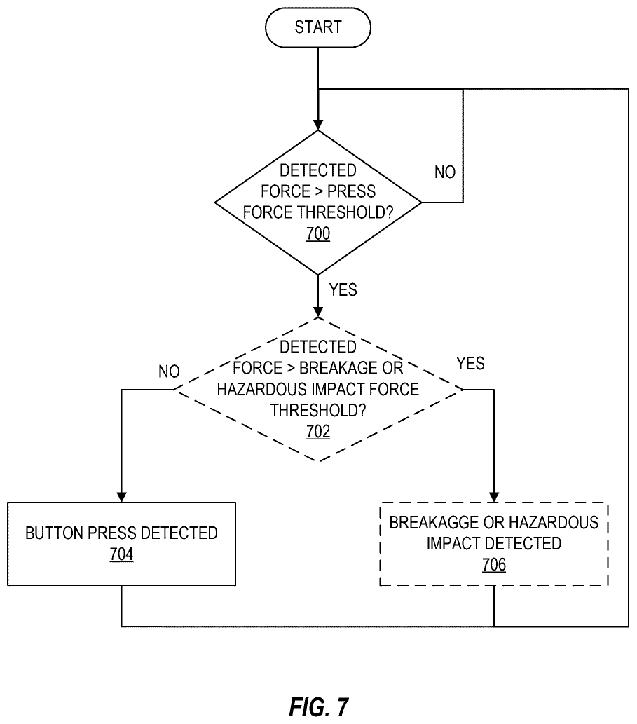

FIG. 7 is a flow chart that illustrates one example process that may be performed by the smart window controller 302 to detect button press and/or a breakage/hazardous impact, in accordance with one example embodiment of the present disclosure. Optional steps are represented by dashed lines. This procedure may be used for step 608 and step 614 of FIG. 6. As illustrated, the smart window controller 302 determines whether the amount of force detected via a MEMS-based force sensor 104 exceeds a press force threshold (step 700). If so, optionally, the smart window controller 302 determines whether the detected amount of force is greater than a breakage or hazardous impact force threshold (step 702). The breakage or hazardous impact force threshold is greater than (e.g., much greater than) the press force threshold. If the detected amount of force is greater than the press force threshold and optionally not greater than the breakage or hazardous impact force threshold, the smart window controller 302 determines that a button press has been detected (step 704). Conversely, if the detected amount of force is greater than the breakage or hazardous impact force threshold, the smart window controller 302 determines that a breakage or hazardous impact has been detected (step 706).

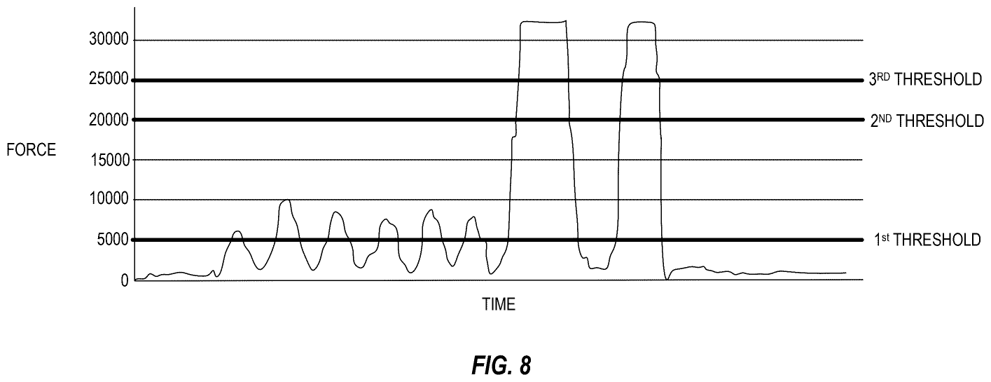

In regard to button press versus breakage/hazardous impact detection using the MEMS-based force sensor 104, FIG. 8 illustrates one example of the output of the MEMS-based force sensor 104 resulting from six presses followed by two breakage/hazardous impacts. In this example, there are three thresholds, namely, a first force threshold for detecting a button press (i.e., the press force threshold) which is 5,000, a second threshold for an upper bound of detecting a button press which is 20,000, and a third threshold for detecting a breakage or hazardous impact (i.e., the breakage or hazardous impact force threshold) is 25,000, where the first threshold is less than the second threshold which is less than the third threshold. Note that the example values of 5,000, 20,000, and 25,000 are only examples. The threshold values may vary depending on the particular implementation (e.g., based on the thickness of the glass, based on the particular MEMS-based force sensor(s) used, etc.).

It should be noted that while the embodiments described herein use the MEMS-based force sensor(s) 104, in alternative embodiments, capacitive-touch sensor(s) may be used. Also, while the UWB sensor 112 is described herein as being used to detect the presence of occupant(s), other technologies such as, for example, Infrared (IR) sensor(s), video camera(s) (with associated processing of the video stream(s) to detect occupant(s)), or the like may be used instead of (or in addition to) the UWB sensor 112 to detect the presence of an occupant(s).

It is contemplated that any of the foregoing aspects, and/or various separate aspects and features as described herein, may be combined for additional advantage. Any of the various embodiments as disclosed herein may be combined with one or more other disclosed embodiments unless indicated to the contrary herein.

Those skilled in the art will recognize improvements and modifications to the preferred embodiments of the present disclosure. All such improvements and modifications are considered within the scope of the concepts disclosed herein and the claims that follow.

What is claimed is:

1. A smart window having a controllable tint state, the smart window comprising:
one or more glass panels; and
one or more Micro-Electro-Mechanical System (MEMS)-based force sensors either integrated directly with at least one of the one or more glass panels or integrated into a mullion or transom adjacent to the one or more glass panels.

2. The smart window of claim 1, wherein at least one of the one or more MEMS-based force sensors is configured to function as a button.

3. The smart window of claim 2, further comprising one or more Ultra Wideband (UWB) sensors configured to detect presence of one or more occupants.

4. The smart window of claim 2, further comprising one or more Ultra Wideband (UWB) sensors configured to detect presence of one or more occupants within a certain distance from the smart window or within a room or space in which the smart window is located.

5. The smart window of claim 2, further comprising a temperature sensor integrated directly with at least one of the one or more glass panels or integrated into a mullion or transom adjacent to the one or more glass panels.

6. The smart window of claim 5, wherein at least one of the one or more MEMS-based force sensors is integrated with the temperature sensor.

7. The method of claim 1, wherein the one or more glass panels comprise a glass panel having a first side that faces a room or space in which an occupant may be present and a second side that is opposite to the first side, and the one or more MEMS-based force sensors comprises a MEMS-based force sensor that is attached to the second side of the glass panel and configured to sense a force applied to the first side of the glass panel and thereby function as a button.

8. The method of claim 1, wherein the one or more MEMS-based force sensors comprises a MEMS-based force sensor that is attached to an interior side of a surface of a mullion or transom adjacent to the one or more glass panels and configured to sense a force applied to the surface of the mullion or transom and thereby function as a button.

9. The method of claim 1, further comprising a controller configured to control a feature of the smart window based on one or more inputs, the one or more inputs comprising an output of the MEMS-based force sensor configured to function as a button.

10. The method of claim 9, wherein the feature of the smart window controlled by the controller is a tint state of the smart window.

11. A method performed by a controller of a smart window, the method comprising:
detecting a user input based on an output of a Micro-Electro-Mechanical System (MEMS)-based force sensor that is either integrated directly with a glass panel of the smart window or integrated into a mullion or transom adjacent to the glass panel of the smart window, the user input comprising either a press or a sequence of presses on a surface of either the glass panel of the smart window or the mullion or transom adjacent to the glass panel of the smart window; and
controlling a feature of the smart window based on the detected user input.

12. The method of claim 11, wherein controlling the feature of the smart window based on the detected user input comprises setting a tint state of the smart window based on the detected user input.

13. The method of claim 11, wherein detecting the user input comprises detecting a press based on one or more force thresholds for press detection.

14. The method of claim 13, wherein detecting the press comprises comparing the output of the MEMS-based force sensor, which is indicative of an amount of force sensed by the MEMS-based force sensor, to the one or more force thresholds for press detection.

15. The method of claim 14, wherein detecting the press comprises comparing the output of the MEMS-based force sensor, which is indicative of an amount of force sensed by the MEMS-based force sensor, and controlling the feature of the smart window comprises controlling the feature of the smart window based on the amount of force sensed by the MEMS-based force sensor.

16. The method of claim 11, wherein detecting the user input comprises detecting a sequence of presses, and controlling the feature of the smart window comprises controlling the feature of the smart window based the detected sequence of presses.

17. The method of claim 11, wherein detecting the user input comprises detecting a sequence of presses consisting of a detected number of presses, and controlling the feature of the smart window comprises controlling the feature of the smart window based the detected number of presses.

18. The method of claim 11, wherein two or more MEMS-based force sensors, including the MEMS-based force sensor, are either integrated directly with the glass panel of the smart window or integrated into a mullion or transom adjacent to the glass panel of the smart window, and controlling the feature of the smart window comprises controlling the feature of the smart window based on which of the two or more MEMS-based force sensors for which the user input is detected.

19. The method of claim 11, wherein the feature of the smart window controlled based on the detected user input is a tint state of the smart window, and the method further comprises, prior to detecting the user input, setting the tint state of the smart window based on one or more environmental conditions.

20. The method of claim 11, wherein the one or more environmental conditions comprise any one or more of the following: presence of one or more occupants in a room or space in which the smart window is located, temperature, or presence or level of sunlight.

21. The method of claim 11, further comprising detecting whether a breakage or hazardous impact on the smart window has occurred based on an output of the MEMS-based force sensor.

22. The method of claim 21, wherein detecting whether a breakage or hazardous impact on the smart window has occurred comprises comparing the output of the MEMS-based force sensor, which is indicative of an amount of force sensed by the MEMS-based force sensor, to a force threshold for breakage or hazardous impact detection.

23. The method of claim 22, wherein the force threshold for breakage or hazardous impact detection is programmable and/or customizable.

24. The method of claim 11, further comprising detecting whether a breakage or hazardous impact on the smart window has occurred based on the output of the MEMS-based force sensor and outputs of one or more additional MEMS-based force sensors integrated with the smart window.

25. The method of claim 11, wherein the controller is integrated with the smart window.

26. The method of claim 11, wherein the controller is separate from the smart window.

27. The method of claim 11, wherein the smart window is one of a group of smart windows, and controlling the feature of the smart window based on the detected user input comprises detecting the feature of the group of smart windows based on the detected user input.

28. A system comprising:
a smart window having a controllable feature, the smart window comprising one or more glass panels and one or more Micro-Electro-Mechanical System (MEMS)-based force sensors either integrated directly with at least one of the one or more glass panels or integrated into a mullion or transom adjacent to the one or more glass panels; and
a controller configured to:
detect a user input based on an output of at least one of the one or more MEMS-based force sensors, the user input comprising either a press or a sequence of presses on a surface of either the glass panel of the smart window or the mullion or transom adjacent to the glass panel of the smart window; and
control the feature of the smart window based on the detected user input.

29. The system of claim 28, wherein the feature is a tint state of the smart window.

30. A non-transitory computer-readable medium comprising instructions executable by one or more processors of a controller for controlling a smart window, whereby the one or more processors cause the controller to:
detect a user input based on an output of a Micro-Electro-Mechanical System (MEMS)-based force sensor that is either integrated directly with a glass panel of the smart window or integrated into a mullion or transom adjacent to the glass panel of the smart window, the user input comprising either a press or a sequence of presses on a surface of either the glass panel of the smart window or the mullion or transom adjacent to the glass panel of the smart window; and
controlling a feature of the smart window based on the detected user input.
